(19) United States
(12) Patent Application Publication
(10) Pub. No.: US 2016/0279463 A1
(43) Pub. Date: Sep. 29, 2016

(54) METHOD FOR FABRICATING SLIP-PROOF PATTERN ON SPORT INSTRUMENT

(71) Applicant: Li Ting Feng Co. Ltd., Tainan City (TW)

(72) Inventor: Wen-Sung CHANG, Tainan City (TW)

(21) Appl. No.: 14/705,422

(22) Filed: May 6, 2015

(30) Foreign Application Priority Data
Mar. 26, 2015 (TW) 104109682

(51) Int. Cl. A63B 21/00; B05D 5/00; B05D 3/02; B05D 7/02

(52) U.S. Cl. CPC A63B 21/4037; B05D 7/02; B05D 5/00; B05D 3/0272

(57) ABSTRACT

A method for fabricating a slip-proof pattern on a sport instrument comprises steps: providing a sport instrument with at least one slip-proof surface; preparing a coating material comprising a paint and a foaming agent evenly mixed thereinside; using the coating material to draw a slip-proof pattern on the slip-proof surface, and keeping the sport instrument still until the slip-proof pattern is dried and fixed; and heating the slip-proof pattern to make the foaming agent of the coating material generate gas and make the slip-proof pattern expand and protrude from the slip-proof surface. The conventional technology fabricates slip-proof strips and a sport instrument into a one-piece component. The present invention replaces the conventional technology with a method of directly forming a slip-proof pattern in a drawing or spraying way to simplify the complicated process and reduce the cost.

### FIELD OF THE INVENTION

The present invention relates to a method for fabricating a slip-proof pattern on a sport instrument, particularly to a method for fabricating a slip-proof pattern on a sport instrument in a drawing or printing way.

### BACKGROUND OF THE INVENTION

Busy and hurry causes modern people to experience high tension, and high tension further causes people to suffer from stiffness and aching in the neck and shoulder, especially the office workers who sit working with their computers all day long. Thus, many people choose yoga—an exercise to achieve extensibility and pliability—to relax their minds and bodies in their spare time. While someone is exercising yoga, he usually puts a yoga mat or the like on the ground for comfort. A yoga mat or the like products are normally made of rubber or a soft and stretchable plastic material. Sometimes, a slip-proof fabric or a piece of slip-proof adhesive paper with convex dots is struck to the bottom of a yoga mat to prevent the yoga mat from slippage during yoga exercise. The slip-proof fabric or adhesive paper is stuck to a yoga mat with an adhesive agent. The gluing process is troublesome. Further, the environmental factors, such as high temperature, will cause the adhesive agent to deteriorate or lose its adhesiveness. In order to solve the problems, related manufacturers developed a yoga mat made of a foaming material having an intrinsic slip-proof effect. For example, a Taiwan patent No. M476045 disclosed a plate structure with a wear-resistant layer and a buffer layer fabricated into a one-piece component. The plate structure comprises at least one wear-resistant layer having a first slip-proof pattern and at least one buffer layer having a second slip-proof pattern, wherein the wear-resistant layer and the buffer layer respectively have different densities and different hardnesses. The materials of the wear-resistant layer and the buffer layer are simultaneously injected into a mold to generate a foaming rubber plate having slip-proofness and wear-resistance. Besides, there is also a technology embossing a slip-proof pattern on a yoga mat.

Two prior arts have been introduced above: one fabricates the slip-proof pattern and the plate material simultaneously in a single injection-molding process; the other one fabricates a mat firstly and then embosses the slip-proof pattern on the mat. No matter which prior art is used, while intending to fabricate mats or plates with different slip-proof patterns, the manufacturer must prepare different molds for different slip-proof patterns. Further, the complicated the slip-proof pattern, the higher the cost of the mold.

Thus, the embossing technology or the one piece-component injection-molding technology is unable to meet the trend of customized fabrication any more. Therefore, the conventional technology has much room to improve.

### SUMMARY OF THE INVENTION

One objective of the present invention is to solve the problem that the conventional technology needs different dedicated molds to fabricate different slip-proof patterns for sport instruments in complicated processes and high cost.

To achieve the abovementioned objective, the present invention proposes a method for fabricating a slip-proof pattern on a sport instrument, which comprises steps: providing a sport instrument having at least one slip-proof surface; preparing a coating material comprising a paint and a foaming agent mixed fully and uniformly; using the coating material to draw a slip-proof pattern on the slip-proof surface, and keeping the sport instrument still until the slip-proof pattern is dried and fixed; heating the slip-proof pattern to make the foaming agent of the coating material generate gas and make the slip-proof pattern expand and protrude from the slip-proof surface.

In one embodiment, the sport instrument is a yoga brick, a yoga pillar or a yoga mat.

In one embodiment, the sport instrument is made of a material selected from a group consisting of polyvinylchloride (PVC) thermoplastic rubber (TPR), thermoplastic elastomer (TPE), ethylene-vinylacetate copolymer (EVA), and nitrile-butadiene rubber (NBR).

In one embodiment, the paint and the foaming agent is mixed by a ratio of 7:3 in the coating material.

In one embodiment, the coating material is applied onto the slip-proof surface with a spray gun, and the spray gun has a material chamber for receiving the coating material.

In one embodiment, the slip-proof pattern comprises a plurality of repeated figures, letters or characters.

In one embodiment, the slip-proof pattern is heated at a temperature of 80-180° C.

In comparison with the conventional technology, the present invention has the following advantages:

1. The present invention can fabricate numerous different slip-proof patterns without using any mold but merely via spraying a coating material comprising a paint and a foaming agent on the surface of a sport instrument. Therefore, the present invention can save complicated procedures, decrease fabrication cost, and increase esthetics and applications of products.

2. The present invention mixes the paint and the foaming agent to form a coating material, sprays the coating material to form a pattern on a sport instrument, and heats the pattern to form a slip-proof pattern automatically adhering to the sport instrument. Therefore, the present invention is exempted from the gluing process of the conventional technology.

### BRIEF DESCRIPTION OF THE DRAWINGS

FIG. 1 shows a flowchart of a method for fabricating a slip-proof pattern on a sport instrument according to one embodiment of the present invention.

FIG. 2 is a diagram schematically showing a sport instrument before fabrication.

FIG. 3 is a diagram schematically showing a slip-proof pattern is drawn according to one embodiment of the present invention.

FIG. 4 is a diagram schematically showing a slip-proof pattern is heated according to one embodiment of the present invention.

FIG. 5 is a side view schematically showing a sport instrument with a slip-proof pattern according to a first embodiment of the present invention.

FIG. 6 is a perspective view schematically showing a sport instrument with a slip-proof pattern according to a second embodiment of the present invention.

FIG. 7 is a perspective view schematically showing a sport instrument with a slip-proof pattern according to a third embodiment of the present invention.

### DETAILED DESCRIPTION OF THE PREFERRED EMBODIMENTS

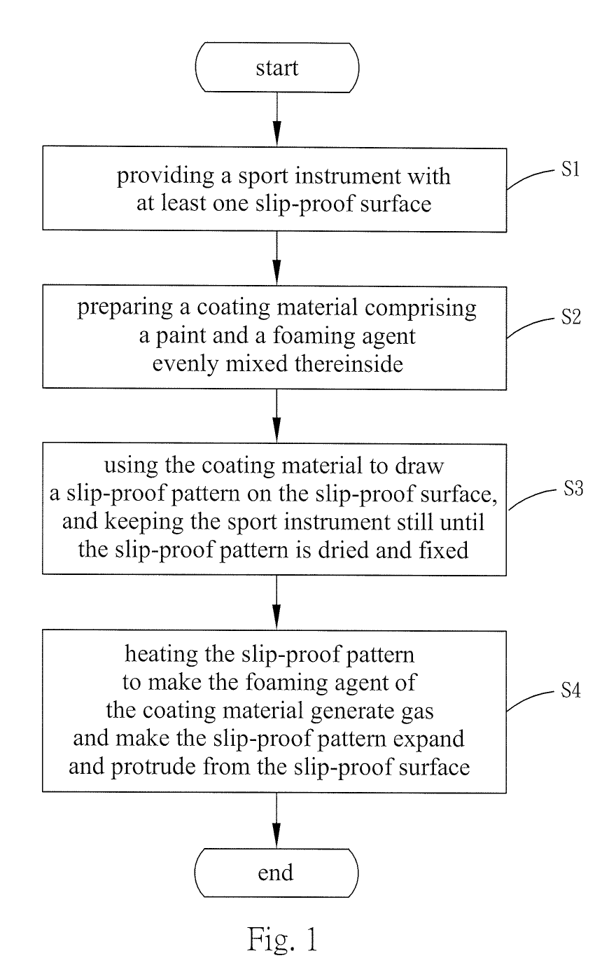

Refer to FIG. 1 for a flowchart of a method for fabricating a slip-proof pattern on a sport instrument according to one embodiment of the present invention.

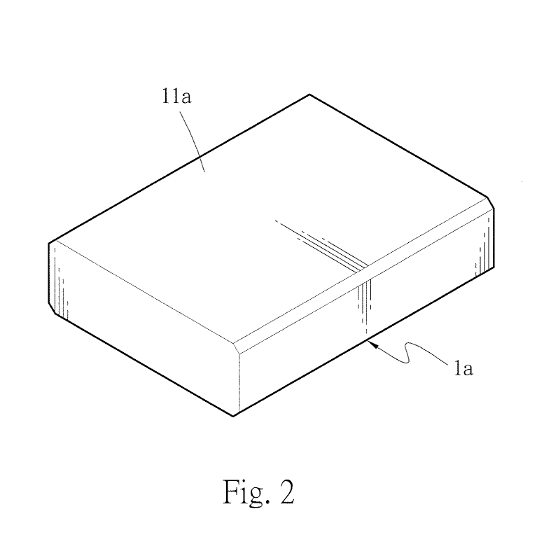

In Step S1, provide a sport instrument 1a with at least one slip-proof surface 11a, as shown in FIG. 2. In one embodiment, the sport instrument 1a is a yoga brick; the slip-proof surface 11a is between the sport instrument 1a and the ground, preventing the yoga brick from slipping during usage. In the present invention, the sport instrument 1a may be but is not limited to be made of a material selected from a group consisting of polyvinylchloride (PVC) thermoplastic rubber (TPR), thermoplastic elastomer (TPE), ethylene-vinylacetate copolymer (EVA), and nitrile-butadiene rubber (NBR).

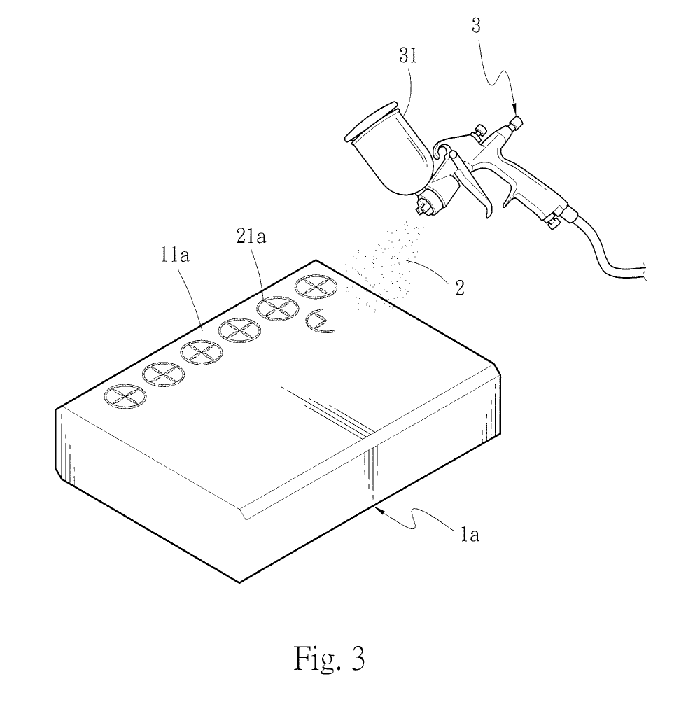

In Step S2, prepare a coating material 2 comprising a paint and a foaming agent evenly mixed thereinside, as shown in FIG. 3. In the succeeding steps, the mixture of the paint and the foaming agent will be heated to generate a lot of gas, and the paint will expand to form a crude and porous surface. Preferably, the paint and the foaming agent are mixed by a ratio of 7:3 in the coating material 2, whereby the paint can be fully foamed with the pattern undistorted. The present invention adopts a lipophilic paint as the paint, and uses toluene or turpentine as the thinner to modify the viscosity of the paint. The foaming agent may be a physical foaming agent, such as the foaming agent of a hydrocarbon group, or a hydrogenated fluorochlorohydrocarbon group, or a chemical foaming agent, such as the ADC (azodicarbonamide or azobisformamide) foaming agent, depending on the requirement of the user and the material of the sport instrument 1a.

In Step S3, use the coating material 2 to draw a slip-proof pattern 21 a on the slip-proof surface 11a, and keep the sport instrument 1a still until the slip-proof pattern 21a is dried and fixed, as shown in FIG. 3. In one embodiment, a spray gun 3 is used to apply the coating material 2 onto the slip-proof surface 11a; the coating material 2 is set in a material chamber 31 and sprayed on the slip-proof surface 11a to form the slip-proof pattern 21a. In one embodiment, an automatic printing device (not shown in the drawing), such as a printer, is used to print the slip-proof pattern 21a on the slip-proof surface 1a. In one embodiment, the slip-proof pattern 21a includes a plurality of repeated figures, letters or characters, which have a decorative and slip-proof effect. In one embodiment, the slip-proof pattern includes an arrow pattern or usage illustrations, which have an instructive and slip-proof effect. In the specification, the term “dried and fixed” means that the slip-proof pattern 21a is dried to such an extent that neither the coating material 2 flows nor the slip-proof pattern 21 distorts while the sport instrument 1a is moved or tilted.

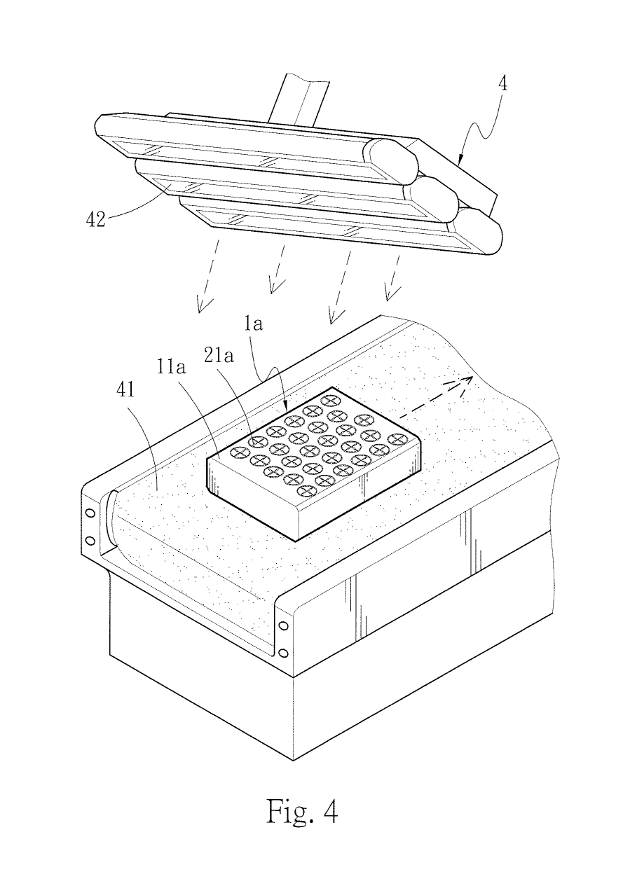

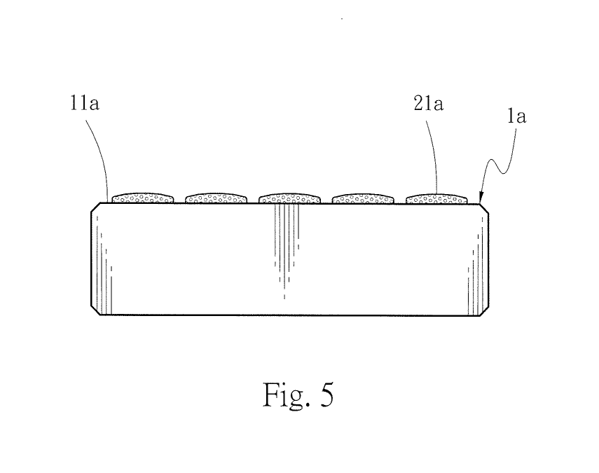

In Step S4, heat the slip-proof pattern 21a, as shown in FIG. 4. Thus, the foaming agent of the coating material 2 generates gas, which makes the slip-proof pattern 21a expand and protrude from the slip-proof surface 11a. The slip-proof pattern 21a is heated by a heating device 4. In one embodiment, the heating device 4 is an oven incorporating a conveyor 41 and heating tubes 42. The heating duration can be controlled by the speed of the conveyor 41. Dependent on the foaming state, the heating duration is within 1-2 minutes, and the heating temperature is preferably at 80-180° C. As shown in FIG. 5, after heating, the foaming agent convexes the slip-proof pattern 21a and makes the slip-proof surface 11a become a roughened surface, which provides friction to generate a slip-proof effect while the sport instrument 1a is being used.

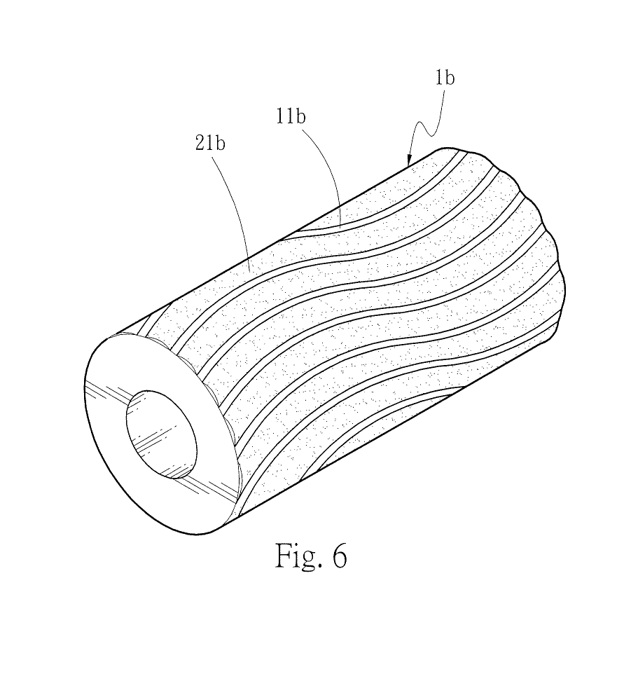

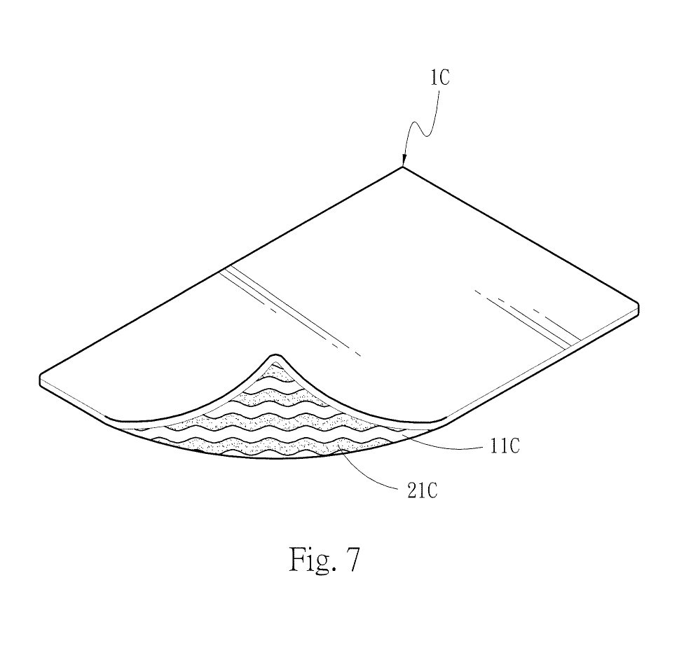

Refer to FIG. 6 for a second embodiment, wherein the sport instrument 1b is exemplified by a yoga pillar. The slip-proof pattern 21b is formed on the sport instrument 1b, providing friction for the user while the user is holding, lying on or leaning on the sport instrument 1b, and preventing the sport instrument 1b from rolling while the user does not use the sport instrument 1b. Refer to FIG. 7 for a third embodiment, wherein the sport instrument 1c is exemplified by a yoga mat. The slip-proof pattern 21c is formed on the slip-proof surface 11c that contacts the ground, preventing the yoga mat from slipping during usage.

In conclusion, the present invention proposes a method for fabricating a slip-proof pattern on a sport instrument, which comprises steps: preparing a coating material; using the coating material to draw a slip-proof pattern on a sport instrument, and keeping the sport instrument still for drying the coating material; heating the coating material to make the foaming agent generate gas and the slip-proof pattern expand. Thereby, the present invention can fabricate numerous different slip-proof patterns on sport instruments without using any mold. Therefore, the present invention is exempted from complicated procedures and saves a lot of cost in fabricating slip-proof patterns.

What is claimed is:

1. A method for fabricating a slip-proof pattern on a sport instrument, comprising steps:
providing a sport instrument with at least one slip-proof surface;
preparing a coating material comprising a paint and a foaming agent evenly mixed thereinside;
using the coating material to draw a slip-proof pattern on the slip-proof surface, and keeping the sport instrument still until the slip-proof pattern is dried and fixed; and
heating the slip-proof pattern to make the foaming agent of the coating material generate gas and make the slip-proof pattern expand and protrude from the slip-proof surface.

2. The method for fabricating a slip-proof pattern on a sport instrument according to claim 1, wherein the sport instrument is a yoga brick, a yoga pillar or a yoga mat.

3. The method for fabricating a slip-proof pattern on a sport instrument according to claim 1, wherein the sport instrument is made of a material selected from a group consisting of polyvinylchloride (PVC) thermoplastic rubber (TPR), thermoplastic elastomer (TPE), ethylene-vinylacetate copolymer (EVA), and nitrile-butadiene rubber (NBR).

4. The method for fabricating a slip-proof pattern on a sport instrument according to claim 1, wherein the paint and the foaming agent is mixed by a ratio of 7:3 in the coating material.

5. The method for fabricating a slip-proof pattern on a sport instrument according to claim 1, wherein the coating material is applied onto the slip-proof surface with a spray gun, and wherein the spray gun has a material chamber for receiving the coating material.

6. The method for fabricating a slip-proof pattern on a sport instrument according to claim 1, wherein the slip-proof pattern includes a plurality of repeated figures, letters or characters.

7. The method for fabricating a slip-proof pattern on a sport instrument according to claim 1, wherein the slip-proof pattern is heated at a temperature of 80-180° C.
